(19) United States
(12) Patent Application Publication
(10) Pub. No.: US 2010/0248606 A1
(43) Pub. Date: Sep. 30, 2010

(54) VENTILATION HOLE WATERPROOF STRUCTURE OF ON-BOARD COMPONENT

(75) Inventor: Tsuyoshi KANDA, Obu-city (JP)

Correspondence Address: NIXON & VANDERHYE, P.C., 901 NORTH GLEBE ROAD, 11TH FLOOR, ARLINGTON, VA, 22203, US

(73) Assignee: DENSO CORPORATION, Kariya-city (JP)

(21) Appl. No.: 12/730,519

(22) Filed: Mar. 24, 2010

(30) Foreign Application Priority Data
Mar. 26, 2009 (JP) 2009-75576

(51) Int. Cl. B60H 1/24; F24F 7/00

(52) U.S. Cl. 454/145

(57) ABSTRACT

A ventilation hole waterproof structure of an on-board component includes an on-board component main body and an attachment member. The main body includes a housing, a ventilation hole, and a waterproof filter. The ventilation hole is provided to the housing extending through the housing to provide communication between an inside and an outside of the housing. The attachment member has a connecting part connected to the main body. The attachment member has an attachment surface that extends from at least an upper end of the connecting part downwardly. The housing has a connecting surface, which is connected to the connecting part, and which is opposed to the attachment surface with a clearance therebetween. The ventilation hole has an outside opening at an external wall surface of the housing. The waterproof filter is fixed to the external wall surface to cover the outside opening.

### CROSS REFERENCE TO RELATED APPLICATION

This application is based on and incorporates herein by reference Japanese Patent Application No. 2009-75576 filed on Mar. 26, 2009.

### BACKGROUND OF THE INVENTION

1. Field of the Invention

The present invention relates to a ventilation hole waterproof structure of an on-board component (vehicular on-board component, on-vehicle equipment), which is mounted on a vehicle.

2. Description of Related Art

In a conventional vehicular on-board component, in order to prevent moisture condensation inside a main body of the on-board component, a partition wall of a housing of the on-board component main body is usually provided with a ventilation hole that extends through the partition wall to communicate between the inside and the outside of the main body. The above partition wall is a sectioning wall that defines the inside and the outside of the main body. The vehicular on-board component may be an actuator having a motor and a drive force transmission mechanism or may be an electronic control device (control unit).

As one example of a ventilation hole structure of the vehicular on-board component, as shown in FIGS. 6A and 6B, there is proposed an actuator that has a partition wall 102 of a housing 101 provided with a ventilation hole 103 (see, for example, JP-A-H05-003637).

As shown in FIG. 6B, the actuator has a filter 104 that is provided at an outer surface of the partition wall 102 such that the filter 104 covers an outside opening of the ventilation hole 103. The filter 104 is provided between (a) a bottom surface of the recess 106 of a projection cylindrical portion 105 (an opening peripheral portion of the ventilation hole 103) and (b) an annular end surface of a bush 107, and is fixed to an opening peripheral portion of the ventilation hole 103. More specifically, the projection cylindrical portion 105 outwardly projects from an external wall surface of the partition wall 102 of the housing 101.

Also, the partition wall 102 of the housing 101 has a cap 108 fixed thereto for preventing the filter 104 and the bush 107 from being detached. Further, a flange 111 of the bush 107 and a sectioning wall 112 inside the cap 108 do not contact each other. Thus, a clearance 113 having a maze-like structure is formed between the bush 107 and the cap 108 as shown in FIG. 6B.

Then, an inside and an outside of the housing 101 are communicated with each other through the ventilation hole 103, the clearance 113 formed between (a) the flange 111 of the bush 107 and (b) the sectioning wall 112 of the cap 108, and a communication hole 115 formed at a cylindrical portion 114 of the cap 108.

An actuator, which contains therein a motor and a drive force transmission mechanism, has the above configuration of the ventilation hole 103 and the clearance 113. More specifically, the ventilation hole 103 extends through the partition wall 102 of the housing 101 in the thickness direction, and is closed by the filter 104. The clearance 113 is communicated with the ventilation hole 103 and has the maze-like structure. As a result, it is possible to prevent water or foreign objects from entering into the actuator through the ventilation hole 103.

Also, FIG. 7 shows another ventilation hole structure for a vehicular on-board component for a throttle opening degree detector proposed in JP-A-H10-061508, for example. As shown in FIG. 7, in the ventilation hole waterproof structure, a housing is mounted to a mount tubular portion 120 of the throttle body.

The mount tubular portion 120 shown in FIG. 7 has a first passage 121 and a second passage 122. The first passage 121 is positioned at a lower part of the tubular portion 120 in a vertical direction, and the second passage 122 is positioned at an upper part of the tubular portion 120 in the vertical direction. A first outer hole 123 is provided between the first passage 121 and the second passage 122 for communication with an external air. Also, a second outer hole 124 is provided at an upper end of the second passage 122 in the vertical direction for communication with external air, and the second outer hole 124 has an opening diameter greater than an opening diameter of the first outer hole 123.

Also, an inner hole 125 is provided at a lower end of the first passage 121 in the vertical direction for communication with an internal space formed between the throttle body and the housing. Also, the first outer hole 123 and the second outer hole 124 are communicated with each other through the second passage 122 in a circumferential direction of an internal wall surface 126. However, the first outer hole 123 is communicated with the inner hole 125 through the first passage 121 in the circumferential direction and in the axial direction of the internal wall surface 126. Thus, the passage and holes form a bent air passage altogether, and in other words, the bent air passage has a maze-like structure, for example.

In the normal use, the inner hole 125, the first passage 121, and the first outer hole 123 serve as a ventilation hole for draining water, such as rain water, that has entered into the internal space.

As above, because the throttle opening degree detector has the ventilation hole having the maze-like structure, the entry of water through the ventilation hole is prohibited.

However, the actuator of JP-A-H05-003637 has the following disadvantages. First Disadvantage of JP-A-H05-003637 will be described. Water and foreign objects may be accumulated in the cap 108. It is not possible to mount the actuator in a manner that the projection part or the bottom end of the cap 108 faces downwardly in the vertical direction because the cap 108 needs to close the ventilation hole 103 of the housing 101. In other words, it is not possible to mount the actuator of JP-A-H05-003637 in a manner that the direction B in FIG. 6B corresponds to the vertically downward direction.

As a result, in the actuator of JP-A-H05-003637, the cap 108 is required to be mounted to the housing 101 such that a mount direction of the cap 108 relative to the housing 101, in which direction the cap 108 is mounted to the housing 101, is at least horizontal (direction B in FIG. 6B). In other words, the cap 108 is required to be mounted to the housing 101 such that at least the surface of the projection end of the cap 108 is perpendicular to the horizontal direction.

Second Disadvantage of JP-A-H05-003637 will be described. Due to First Disadvantage of JP-A-H05-003637, the change of the position of the ventilation hole 103 of the housing 101 may be required depending on the mount direction of the cap 108. Thus, the standardization of the component, such as the housing 101, becomes difficult.

Third Disadvantage of JP-A-H05-003637 will be described. In order to prevent the entry of water and foreign objects into the housing 101 through the ventilation hole 103 of the housing 101, the bush 107 and the cap 108 are required in addition to the filter 104, as shown in FIG. 6B. As a result, the number of components and the assembly manpower are excessively required, and thereby product cost may increase disadvantageously.

Fourth Disadvantage of JP-A-H05-003637 will be described. The size of the whole actuator may become greater as the increase of the number of components assembled to an outer surface of an outer wall part (hollow cylindrical attachment portion) of the housing 101, to which the ventilation hole 103 is formed. For example, the above assembled components include the filter 104, the bush 107 and the cap 108. Thereby, ease of mounting (mountability) of the actuator to the vehicle deteriorates. For example, if the size of the actuator is increased, it is impossible to obtain a sufficient mount space in the engine room that has restriction disadvantageously.

Also, the ventilation hole waterproof structure of the throttle opening degree detector of JP-A-H10-061508 has following disadvantages.

First Disadvantage of JP-A-H10-061508 will be described. Because it is required to place the first outer hole 123 at the vertical lower position, the change of the position of the drain structure is also required in accordance with the mount direction similarly to the case of the ventilation hole waterproof structure of the actuator of JP-A-H05-003637. As a result, the standardization of the component may become difficult disadvantageously.

Second Disadvantage of JP-A-H10-061508 will be described. Because the first outer hole 123 and the second outer hole 124 are exposed to the atmosphere (external air), the first and the second outer holes 123, 124 do not function as drain holes for draining water therein disadvantageously if the first and the second outer holes 123, 124 are covered by sludge or foreign objects.

The above disadvantages of the conventional art become more serious when applied to the on-board component, such as the actuator or the throttle opening degree detector, and specifically, to the engine room on-board component.

FIGS. 8 to 11C describe examples of the actuator used for an air intake apparatus for the internal combustion engine, which apparatus is mounted in the engine room of the vehicle. Disadvantages of the above examples will be described below.

As shown in FIG. 8, the air intake apparatus for the internal combustion engine includes a cartridge 202, multiple intake flow control valves 203 (referred as valves 203), a valve shaft 204, and an actuator. The cartridge 202 is received within an intake manifold 201 of the internal combustion engine. The valves 203 are received within the cartridge 202 (separate intake passage). The valve shaft 204 fixedly supports the valves 203. The actuator actuates the multiple valves 203 through the valve shaft 204 all together in one go.

The actuator is an engine room on-board component (on-vehicle equipment, vehicle component) that is mounted in an engine room of the vehicle. As shown in FIGS. 8 to 10, the actuator includes a bearing holder housing 205 (referred as a housing 205), an actuator housing 206 (referred as a housing 206), a motor 207, and a drive force transmission mechanism (gear reduction mechanism). The housing 205 is fixed to the intake manifold 201. The housing 206 is fastened to the outside of the housing 205. The motor 207 is received and supported within the internal space of the housing 206. The drive force transmission mechanism (gear reduction mechanism) transmits driving force of the motor 207 to the valve shaft 204.

The housing 205 has an oil seal 209 and a ball bearing 210 at an outer periphery of a joint shaft 208 that is fastened to the valve shaft 204.

The gear reduction mechanism includes a worm, a helical gear 211, an impact force absorbing member 212, a spur gear 213, and an output gear 214.

The output gear 214 of the actuator is assembled to an outer periphery of a joint shaft 208 connected to the valve shaft 204 through a stopper lever 215. Torque of the output gear 214 is transmitted to the valve shaft 204 through the stopper lever 215 and the joint shaft 208. As a result, the multiple valves 203 are actuated to open and close in a valve operational range from a valve full closed position to a valve full open position via a valve intermediate position therebetween.

As shown in FIGS. 11A to 11C, the ventilation hole waterproof structure of the actuator employed in the air intake apparatus for the internal combustion engine includes a projection cylindrical portion 221, a ventilation hole 223, a filter 224, a bush 225, and a cap 226. The projection cylindrical portion 221 outwardly projects from an external wall surface of the housing 206. The ventilation hole 223 opens at a bottom surface of a recess 222 of the projection cylindrical portion 221. The filter 224 covers an atmosphere side of the ventilation hole 223. The bush 225 has an attachment surface, to which the filter 224 is fused to. The cap 226 is assembled to an outer periphery of the bush 225.

The inside of the actuator is ventilated to external air through a clearance 227 formed between the bush 225 and the cap 226. For example, the inside of the actuator corresponds to the space adjacent to the motor and the reduction mechanism within the actuator.

Although the ventilation hole waterproof structure of the on-board component of JP-A-H10-061508 slightly different from the ventilation hole waterproof structure of the on-board component of JP-A-H05-003637, First Disadvantage to Fourth Disadvantage of JP-A-H05-003637 are applicable to JP-A-H10-061508. In order to deal with First Disadvantage of JP-A-H05-003637, the ventilation hole 223 is angled such that the ventilation hole 223 faces slightly upwardly relative to the horizontal direction (see FIG. 9).

Second Disadvantage of JP-A-H05-003637 and First Disadvantage of JP-A-H10-061508 will be described.

In the case for the engine room on-board component, such as the actuator shown in FIGS. 8 to 11C, it is substantially impossible to mount the components to the different engines of the vehicle in the identical manner of mounting. Thus, it is very difficult to standardize the mount direction of the actuator, or more specifically, of the cap 226.

Thus, it is required to design an optimal mount direction of mounting the actuator for each engine, and then it is further required to change the direction of the ventilation hole 223 based on the optimal mount direction. In other words, as described in Second Disadvantage of JP-A-H05-003637 and First Disadvantage of JP-A-H10-061508, in the case for a ventilation hole waterproof structure having a restricted mount direction of mounting the on-board component in the engine room, it is required to change the position of the drain structure based on the mount direction, and thereby it is very difficult to standardize the component, such as the housing 206.

Next, Second Disadvantage of JP-A-H10-061508 will be described.

The second outer holes 123, 124 are provided at a vertically lower part of the on-board component, such as the throttle opening degree detector. As a result, in general, foreign objects, such as sludge or dusts, to the engine room on-board component mainly come through being caught by the wheels. In other words, the first and second outer holes 123, 124, which are provided at the vertical lower part of the on-board component, are very likely to be clogged by the above foreign objects.

The engine room on-board component may be exposed to severe temperature change between high and low temperatures. Thus, the ventilation of the engine room on-board component may be caused by the change of the pressure within the actuator. When the ventilation occurs and the actuator is subjected to water simultaneously, the ventilation operation may result in suctioning water into the throttle opening degree detector or into the throttle body if the first and second outer holes 123, 124 are clogged as above. The above phenomenon is very likely to occur for the engine room on-board component, and may cause serious disadvantages.

Even if the first and second outer holes 123, 124 are not clogged, when the first and second outer holes 123, 124 are simultaneously covered by water and the ventilation operation occurs simultaneously, water may be suctioned into the throttle opening degree detector or the throttle body. For example, when the vehicle is washed under high pressure after the running of the vehicle while the engine is still under high-temperature state, the coverage by the water sharply decreases temperature. As a result, the ventilation operation may occur. Specifically, the maze-like structure of the ventilation hole having the restricted air passage is not durable against the ventilation operation.

Also although water may not easily enter into the ventilation hole having the maze-like structure, water may not easily drain out of the ventilation hole once water has entered therein disadvantageously. Thus, the above disadvantage may deteriorate the reliability.

Furthermore, for the case of the ventilation hole waterproof structure of the actuator shown in FIGS. 8 to 11C, the internal space of the intake manifold 201 of the internal combustion engine has negative pressure. In the above configuration, when the oil seal 209 within the housing 205 becomes incapable of sealing the clearance due to some failure, the internal space of the housing 206 of the actuator becomes negative pressure. Thus, there is always generated force that functions to suction water and foreign objects through the ventilation hole 223. Due to the above, the ventilation hole 223 of the engine room on-board component, such as the actuator, requires high reliability against the clogging.

### SUMMARY OF THE INVENTION

The present invention is made in view of the above disadvantages. Thus, it is an objective of the present invention to address at least one of the above disadvantages.

To achieve the objective of the present invention, there is provided a ventilation hole waterproof structure of an on-board component mounted on a vehicle, the ventilation hole waterproof structure including an on-board component main body and an attachment member. The on-board component main body includes a housing, a ventilation hole, and a waterproof filter. The housing defines an inside and an outside of the housing. The ventilation hole is provided to the housing to extend through the housing such that the ventilation hole provides communication between the inside and the outside of the housing. The waterproof filter is provided at a position that corresponds to the ventilation hole. The attachment member has a connecting part connected to the on-board component main body, and the attachment member is fixed to a body of the vehicle. The attachment member has an attachment surface that extends from at least an upper end of the connecting part downwardly in a vertical direction. The housing has a connecting surface, which is connected to the connecting part of the attachment member, and which is opposed to the attachment surface of the attachment member with a clearance formed between the connecting surface and the attachment surface. The ventilation hole has an outside opening that opens at an external wall surface of the housing, which wall surface is opposed to the attachment surface. The waterproof filter is fixed to the external wall surface of the housing by heat fusion such that the waterproof filter covers the outside opening of the ventilation hole.

### BRIEF DESCRIPTION OF THE DRAWINGS

The invention, together with additional objectives, features and advantages thereof, will be best understood from the following description, the appended claims and the accompanying drawings in which:

FIG. 1A is a cross-sectional view illustrating an actuator according to one embodiment of the present invention;

FIG. 1B is a cross-sectional view illustrating a ventilation hole waterproof structure of the actuator according to one embodiment.

FIG. 2 is a cross-sectional view illustrating an air intake apparatus (intake vortex flow generator) for an internal combustion engine according to the one embodiment;

FIG. 3 is a perspective view illustrating a valve unit (TCV) of the one embodiment.

FIG. 4A is a plan view of a motor (power source) and a drive force transmission mechanism (gear reduction mechanism) according to the one embodiment;

FIG. 4B is a side view of the motor and the drive force transmission mechanism according to the one embodiment;

FIG. 5A is a front view of a housing of an actuator main body according to the one embodiment;

FIG. 5B is a side view of the housing of the actuator main body observed in a direction VB in FIG. 5A according to the one embodiment;

FIG. 5C is a cross-sectional view taken along a line VC-VC in FIG. 5A according to the one embodiment;

FIG. 6A is a side view illustrating the actuator according to the first prior art;

FIG. 6B is a cross-sectional view illustrating a ventilation hole waterproof structure of the actuator according to the first prior art;

FIG. 7 is a perspective view illustrating a ventilation hole waterproof structure of a throttle opening degree detector according to the second prior art;

FIG. 8 is a perspective view illustrating an air intake apparatus for an internal combustion engine according to the third prior art;

FIG. 9 is a plan view illustrating an actuator according to the third prior art;

FIG. 10 is a cross-sectional view taken along a line X-X in FIG. 9 according to the third prior art;

FIG. 11A is a plan view illustrating a ventilation hole waterproof structure of the actuator according to the third prior art;

FIG. 11B is a side view illustrating the ventilation hole waterproof structure of the actuator according to the third prior art; and

FIG. 11C is a cross-sectional view taken along a line XIC-XIC in FIG. 11A according to the third prior art.

### DETAILED DESCRIPTION OF PREFERRED EMBODIMENTS

Embodiments of the present invention will be described below with reference to accompanying drawings.

Configuration of one embodiment of the present embodiment will be described.

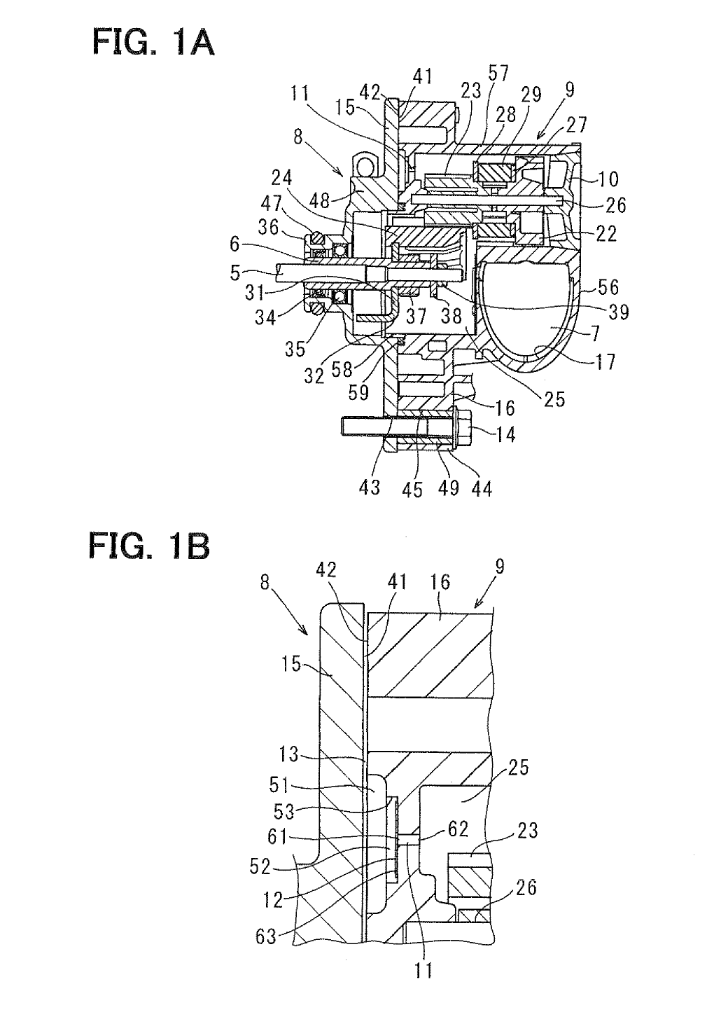

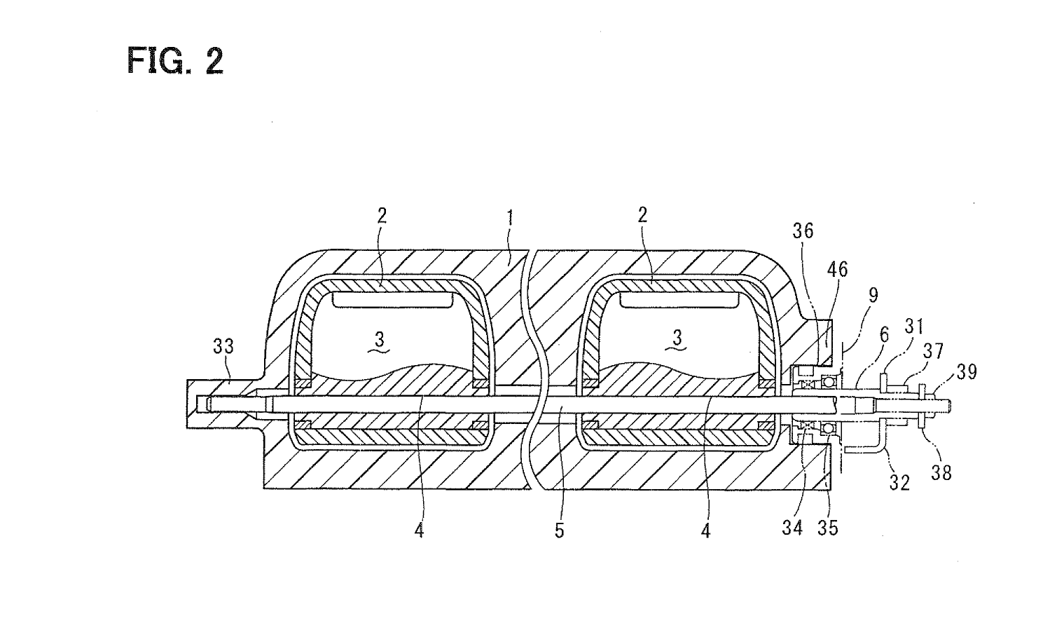

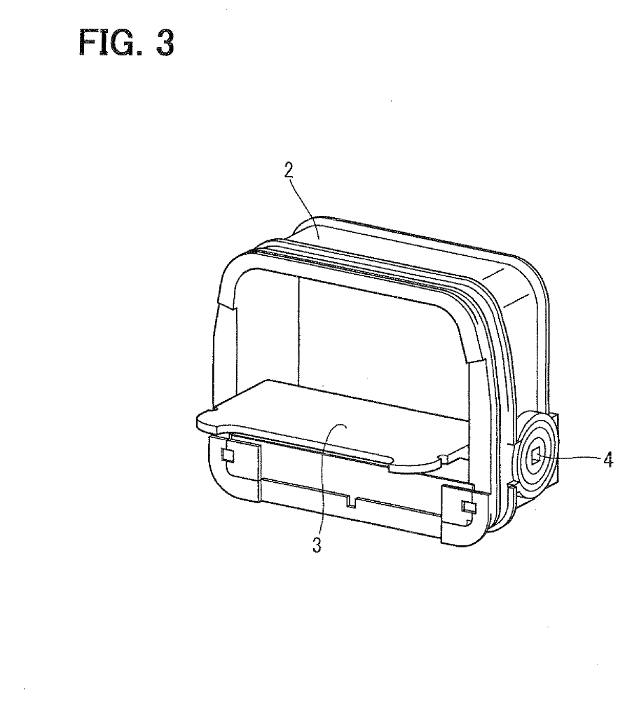

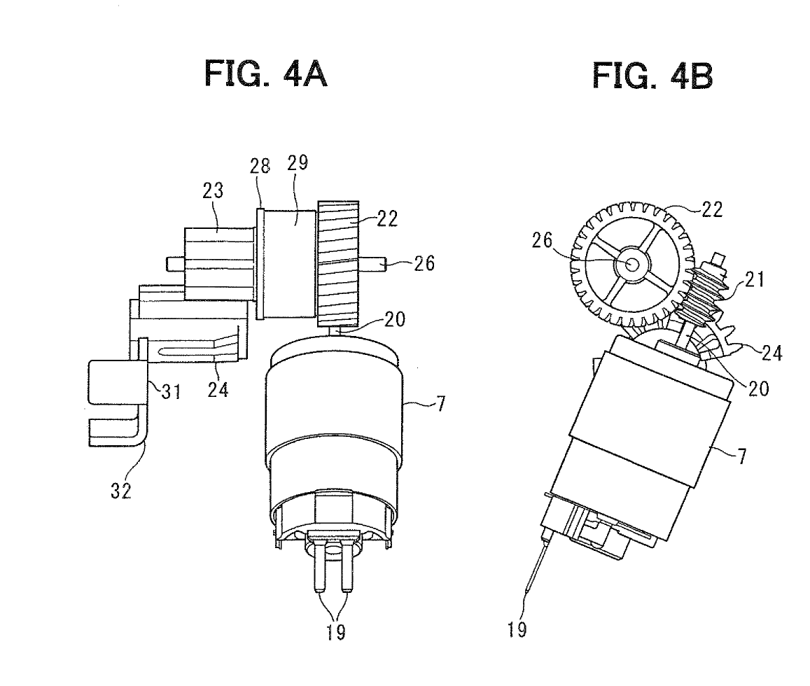

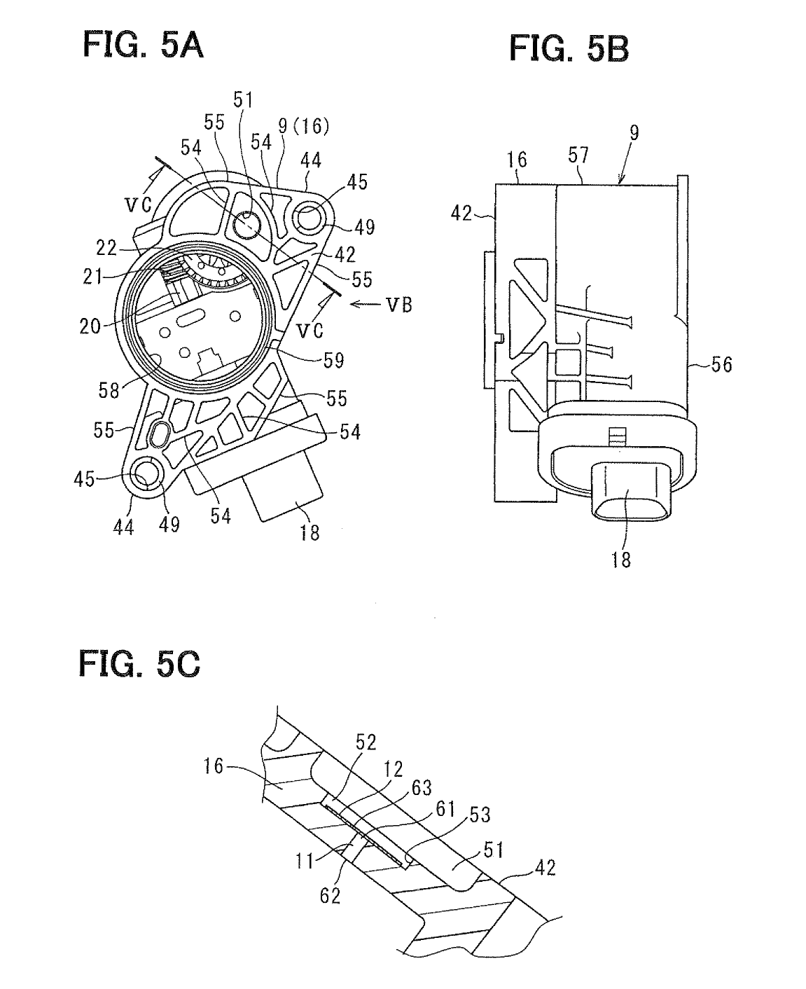

FIGS. 1A through 5C illustrate the one embodiment of the present invention, and FIG. 1A is a diagram illustrating an actuator, FIG. 1B is a diagram illustrating a ventilation hole waterproof structure of the actuator, FIG. 2 is a diagram illustrating an air intake apparatus (intake vortex flow generator) for an internal combustion engine, FIG. 3 is a diagram illustrating a valve unit (TCV), FIGS. 4A and 4B are diagrams illustrating a motor (power source) and a drive force transmission mechanism (gear reduction mechanism), FIGS. 5A and 5B are diagrams illustrating a housing of an actuator main body, and FIG. 5C is a diagram illustrating the ventilation hole waterproof structure of the actuator.

An air intake apparatus for an internal combustion engine of the present embodiment has multiple intake passages that are arranged in parallel with each other in a direction, in which multiple cylinders of the engine are arranged. The intake passages supply intake air to each of the cylinders of the engine. The air intake apparatus of the present embodiment further includes an air cleaner, an electronic throttle apparatus, and an intake vortex flow generator. For example, the engine, the air cleaner, the electronic throttle apparatus, and the intake vortex flow generator are all mounted in an engine room of a vehicle.

The intake vortex flow generator of the present embodiment includes an intake manifold 1 and multiple valve units (TCV). The intake manifold 1 is connected to a position downstream of a throttle body of the electronic throttle in a flow direction of intake air. The multiple valve units control intake air that flows through the intake manifold 1.

The multiple valve units constitute multiple intake flow control valves (tumble flow control valve) that generate intake vortex flow (swirling flow, tumble flow) in a longitudinal direction to a combustion chamber of each cylinder of the engine. The valve units include multiple rectangular tubular cartridges 2 and multiple intake flow control valves 3 (hereinafter referred as valves 3). Each of the rectangular tubular cartridges 2 is received within the intake manifold 1 or within a cartridge housing chamber. Each of the valves 3 has a plate shape and is rotatably received within a separate intake passage of the cartridge 2 such that the valve 3 opens and closes the intake passage. It should be noted that each of the multiple valves 3 has a shaft through hole 4 formed at a rotation center of the valve 3.

The intake vortex flow generator includes a valve shaft 5, a joint shaft 6, an actuator, and an engine control unit (ECU). The valve shaft 5 straightly extends in the direction, in which the multiple separate intake passages are arranged in parallel with each other. The valve shaft 5 is fitted into the joint shaft 6 such that the joint shaft 6 is supported at the outer periphery of the valve shaft 5. The actuator is capable of changing the opening degree (rotation angle) of each valve of the multiple valve units in one go through the valve shaft 5 and the joint shaft 6. The engine control unit (ECU) electronically controls the valve opening degree of the multiple valve units in accordance with the electronic throttle apparatus, an ignition device, and a fuel injection apparatus.

The actuator of the present embodiment is an engine room on-board component (on-vehicle equipment, vehicle component) that is mounted in the engine room of the vehicle, such as an automobile. The actuator employs a motor 7 as a drive source, and employs the drive force transmission mechanism (gear reduction mechanism) to reduce the speed of the motor 7 for outputting motor torque. The actuator serves as a valve drive device that actuates multiple valves 3, which serves as mobile objects (rotors). The actuator includes an actuator main body (on-board component main body) and a bearing holder housing 8 (attachment member). The actuator main body receives therein functional elements, such as the motor 7 and the drive force transmission mechanism. The actuator main body is mounted through the bearing holder housing 8. Hereinafter, the bearing holder housing 8 is referred as a first housing 8.

The actuator main body includes the motor 7, the drive force transmission mechanism, an actuator housing 9 (a housing of the actuator main body), a plug 10, a ventilation hole 11, a waterproof ventilation filter 12, and a clearance 13. The motor 7 generates driving force when supplied with electric power. The drive force transmission mechanism transmits driving force of the motor 7 to the valve shaft 5. The actuator housing 9 is connected to the first housing 8 and is also referred as a second housing 9. The plug 10 (cap) air-tightly seals an opening of the second housing 9. The ventilation hole 11 prevents moisture condensation inside the second housing 9 or inside the actuator main body. The waterproof ventilation filter 12 collects foreign objects, such as dusts and water, in air that passes through the ventilation hole 11. The clearance 13 is formed between a first connecting part of the first housing 8 and a second connecting part of the second housing 9.

The first housing 8 has a first connecting flange 15 (a first connecting part of the attachment member) that is connected or fastened to the second housing 9 through multiple fastening bolts 14. Also, the second housing 9 has a second connecting flange 16 (a second connecting part of the housing) that is bonded or fastened to the first connecting flange 15 of the first housing 8.

It should be noted that details of the ventilation hole waterproof structure of the actuator (engine room on-board component), which includes the first and second housings 8 and 9, the cap 10, the ventilation hole 11, the waterproof ventilation filter 12, and the clearance 13, will be described later.

The motor 7 is electrically controlled by the ECU. The motor 7 is received and supported by a motor receiving space 17 of the second housing 9. Also, a connector 18 is provided to project from an end surface of the second housing 9 in a downward direction in FIG. 5A. The connector 18 holds terminals 19 (external connection terminal, motor power supply terminal) that are electrically connected to a coil of the motor 7. The terminals 19 of the motor 7 are electrically connected with a battery mounted on the vehicle through a motor drive circuit that is electrically controlled by the ECU.

The drive force transmission mechanism includes a gear reduction mechanism (reduction mechanism), which causes the motor 7 to reduce a rotational speed thereof to a predetermined reduction gear ratio, and which simultaneously increases driving force (motor torque) of the motor 7. The gear reduction mechanism has a worm (worm screw) 21, a helical gear 22 (worm wheel), a spur gear 23, and an output gear 24. The worm 21 is fixed to a motor shaft 20 (output shaft) of the motor 7. The helical gear 22 is in mesh with the worm 21. The spur gear 23 is arranged coaxially with the helical gear 22. The output gear 24 is in mesh with the spur gear 23.

Each of the above gears are rotatably received within the second housing 9 of the actuator or within (gear receiving space 25).

The helical gear 22 and the spur gear 23 are rotatably supported at an outer periphery of a shaft 26 (supporting shaft). The shaft 26 is provided to extend in a direction perpendicular a rotational axis of the motor shaft 20 that serves as a worm shaft. The shaft 26 has one axial end portion (left end portion in FIG. 4A) that is press-fitted into a first fitting recess formed at an inner surface of the second connecting flange 16 of the second housing 9. Also, the shaft 26 has the other axial end portion (right end portion in FIG. 4A) that is press-fitted into a second fitting recess formed at an inner surface of the cap 10 that closes the opening of the second housing 9. The inner surface of the cap 10 corresponds to an opposing surface that is opposed to the inner surface of the second connecting flange 16 with the gear receiving space 25 therebetween.

An impact force absorbing member is interposed between the helical gear 22 and the spur gear 23 and is rotatable integrally with the gears 22, 23. The impact force absorbing member includes first and second plates 27, 28 and a rubber elastic body 29 (synthetic rubber material). In a case, where transmission of the motor torque provides excessive impact, the impact force absorbing member reduces impact load transmitted to the worm 21. As a result, the worm 21 is limited from being excessively tightly pressed against the helical gear 22, and thereby it is possible to effectively limit the odd mesh between the worm 21 and the helical gear 22. For example, in the above, the impact force absorbing member reduces impact load transmitted to the worm 21 by a deformation of the rubber elastic body 29 at the moment when the valve 3 is fixed to a full closed position.

The output gear 24 is integrally made of a synthetic resin to have an arc shape. A stopper lever 31 is insert molded at an inner peripheral part of the output gear 24, and the stopper lever 31 is selectively engaged with a fully-opening position stopper (fully-opening position stopper screw) or with a fully-closed position stopper (fully-closed position stopper screw), which are fixed to the first housing 8.

A bending portion 32 of the stopper lever 31 is provided with a fully-opening position stopper contact at one side of the bending portion 32 in one rotational direction or in a valve opening direction. The fully-opening position stopper contact is engageable with the fully-opening position stopper. Thus, when the fully-opening position stopper contact of the stopper lever 31 collides with the fully-opening position stopper, a valve opening degree of the valve unit is regulated to a fully open degree or to be at the full open position. Also, the bending portion 32 of the stopper lever 31 has a fully-closed position stopper contact on the other side of the bending portion 32 in the other rotational direction or in the valve closing direction. The fully-closed position stopper contact is engageable with the fully-closed position stopper. Thus, when the fully-closed position stopper contact of the stopper lever 31 collides with the fully-closed position stopper, the valve opening degree of the valve unit is regulated to be a fully closed degree or to be at the full closed position.

The valve shaft 5 is a polygonal cross section shaft (rectangular steel shaft) that has a cross section taken along a plane perpendicular to a rotational axis of the valve shaft 5. For example, the cross section of the shaft 5 has a polygonal shape (for example, square shape). The valve shaft 5 is integrally made of a metal material. The valve shaft 5 is press-fitted into the shaft through hole 4 of each of the multiple valves 3 such that the valve shaft 5 extends through the multiple valves 3. As a result, the multiple valves 3 are connected with each other such that the opening degree of the multiple valves 3 (a valve opening degree of TCV) are changeable simultaneously together (or changeable in one go). Thus, the valve shaft 5 is capable of fixedly supporting each valve 3 of the multiple valve units. It should be noted that the valve shaft 5 has multiple valve holders that fixedly support the multiple valves 3, respectively. Each valve holder has a cross section having a polygonal shape, which section is taken along a plane perpendicular to the rotational axis of the valve shaft 5.

The valve shaft 5 has one axial end portion (left end portion in FIG. 2) along a rotational axis thereof is directly journaled by a shaft bearing portion 33. The one end portion of the valve shaft 5 is slidable in a rotational direction on the shaft bearing portion 33. The shaft bearing portion 33 has a hollow cylindrical shape and is integrally formed to the intake manifold 1.

In contrast, the valve shaft 5 has the other axial end portion (right end portion in FIG. 2) along the rotational axis. An end portion of the other axial end portion is narrower than the valve holder, and has a cross section having a circular shape, which section is taken along a plane perpendicular to the rotational axis. The end portion of the other axial end portion outer periphery is fitted into the joint shaft 6 that has a hollow cylindrical shape.

The valve shaft 5 and the joint shaft 6 are slidable in the rotational direction and are journaled by a shaft bearing portion 36 of the first housing 8 through an oil seal 34 and a ball bearing 35.

The joint shaft 6 has a hollow cylindrical shape. More specifically, the joint shaft 6 has a cross section having an annular shape, which section is taken by a plane perpendicular to the rotational axis. Also, the joint shaft 6 is integrally made of a metal material. The joint shaft 6 connects the output gear 24 and the stopper lever 31 of the drive force transmission mechanism with the valve shaft 5. Also, the joint shaft 6 has a large diameter part and a small diameter part that has a diameter smaller than a diameter of the large diameter part. An outer peripheral part of the large diameter part of the joint shaft 6 has a cylindrical surface (slide surface) that is rotatably supported by the shaft bearing portion 36 of the first housing 8 through the ball bearing 35 and the oil seal 34.

The small diameter part of the joint shaft 6 has an outer periphery screw part that is threadably engageable with a nut member 37. The nut member 37 is provided for mounting the stopper lever 31 to the large diameter part of the joint shaft 6. Also, the valve shaft 5 has a projection portion that projects from the other axial end of the joint shaft 6 along the rotational axis. The projection portion is provided with an outer periphery screw part that is threadably engageable with a nut member 39. The nut member 39 is provided for mounting a sensor fixing lever 38 to the small diameter part of the joint shaft 6. It should be noted that the sensor fixing lever 38 has a magnet of the valve opening degree sensor or a non-contact magnetic detecting element fixed to the sensor fixing lever 38.

Next, the ventilation hole waterproof structure of the actuator of the present embodiment (engine room on-board component) will be detailed with reference to FIGS. 1, 2, and 5A to 5C.

The ventilation hole waterproof structure of the actuator includes the first and second housings 8 and 9, the cap 10, the ventilation hole 11, the waterproof ventilation filter 12, and the clearance 13.

The first housing 8 is made of a metal material, such as aluminum. The first housing 8 includes the first connecting flange 15 that is fastened to the second housing 9 by the multiple fastening bolts 14. A first connecting surface 41 is formed on a surface of the first connecting flange 15, which surface faces toward the actuator main body. The first connecting surface 41 is connected to the second connecting flange 16 of the second housing 9. The first connecting surface 41 (attachment surface of attachment member) downwardly extends from at least an upper end (most top end portion) of the first connecting flange 15 in a vertical direction (or in a vehicle up-down direction), and has a circular ring shape. Also, the first connecting surface 41 is formed on a plane such that the first connecting surface 41 is opposed to a second connecting surface 42 of the second connecting flange 16 of the second housing 9 with the clearance 13 formed between the first connecting surface 41 and the second connecting surface 42.

Also, the first connecting surface 41 of the first connecting flange 15 is inclined relative to the vertical direction (vehicle up-down direction) by a predetermined inclination angle. It should be noted that the first connecting surface 41 of the first connecting flange 15 may be perpendicular to the vertical direction to extend in a vehicle left-right direction (or in a vehicle width direction). Also, the first connecting surface 41 may alternatively be perpendicular to a vehicle fore-and-aft direction.

Also, both end portions of the first connecting flange 15 in the vehicle up-down direction are provided with first through holes 43 through which the multiple fastening bolts 14 extends. Alternatively, screw holes may be provided to the both end portions for threadably engaging with the multiple fastening bolts 14. The first through holes 43 are formed coaxially with second through holes 45 that are formed on a bolt holder 44 of the second connecting flange 16.

The first housing 8 is fixed to a body of the vehicle. Specifically, because the intake manifold 1 is assembled to the engine that is fixed to a frame or a panel of the vehicle body, the first connecting flange 15 is mounted on an actuator mount surface (actuator attachment surface) together with the second housing 9 through the multiple fastening bolts 14. The actuator mount surface is formed on a side surface of a housing fitting part of the intake manifold 1.

Also, the first housing 8 has the shaft bearing portion 36 that rotatably supports the valve shaft 5 and the joint shaft 6 through the oil seal 34 and the ball bearing 35. The shaft bearing portion 36 is fitted into the housing fitting part 46 of the intake manifold 1. Also, the shaft bearing portion 36 includes first and second cylindrical portions that are provided to surround the periphery of the other axial end portion of the valve shaft 5 and the periphery of the large diameter part of the joint shaft 6 in a circumferential direction.

The first cylindrical portion is an oil seal holder, into which an outer peripheral part of the oil seal 34 is pressed fitted. Also, the second cylindrical portion is a bearing holder, into which an outer race of the ball bearing 35 is press fitted. The bearing holder has an inner diameter that is greater than an inner diameter of the oil seal holder. In other words, a step having a circular ring shape is formed between the bearing holder and the oil seal holder. Also, a ring groove having a circular ring shape is provided at the outer periphery of the oil seal holder in order to mount an O-ring 47 that seals a clearance formed between (a) an inner peripheral surface of the housing fitting part 46 of the intake manifold 1 and (b) an outer peripheral surface of the shaft bearing portion 36.

Also, the first housing 8 has a third cylindrical portion 48 (outer peripheral wall) between the first connecting flange 15 and the shaft bearing portion 36 such that the third cylindrical portion 48 surrounds the periphery of the joint shaft 6 in a circumferential direction. the fully-opening position stopper and the fully-closed position stopper are provided at the inner peripheral part of the third cylindrical portion 48 of the first housing 8. The fully-opening position stopper is engageable with stops the fully-opening position stopper contact of the stopper lever 31, and the fully-closed position stopper is engageable with stops the fully-closed position stopper contact of the stopper lever 31.

The second housing 9 is made of a synthetic resin material. The second housing 9 is an actuator housing that contains therein the motor 7 (the drive source) and the drive force transmission mechanism (the gear reduction mechanism). Also, the second housing 9 has the second connecting flange 16 that is mounted to the actuator mount surface of the intake manifold 1 in a state, where the first connecting flange 15 is interposed between the second connecting flange 16 and the actuator mount surface of the intake manifold 1. The second connecting flange 16 has a second connecting surface 42 that is connected to the first connecting surface 41 of the first connecting flange 15.

Also, the bolt holders 44 (cylindrical portion) at both end portions of the second connecting flange 16 in the vehicle up-down direction are provided with second through holes 45, through which the multiple fastening bolts 14 extend. A metal collar 49 is fitted into the second through hole 45 in order to reinforce the second through hole 45, and the fastening bolt 14 extends through the metal collar 49.

Also, the second connecting flange 16 constitutes a sectioning wall (partition wall) that defines an outside and an inside of the second housing 9. In other words, the second connecting flange 16 defines an inside and an outside of the actuator main body. The second connecting surface 42 of the second connecting flange 16 is an attachment surface (connecting surface of housing) that is opposed to the first connecting surface 41 of the first connecting flange 15 with the clearance 13 formed between the second connecting surface 42 and the first connecting surface 41.

As shown in FIGS. 1A, 1B, and 5A to 5C, the second connecting flange 16 of the second housing 9 has multiple recesses 51 that provide dead spaces (for example, or dead volume, recess part) formed between the first connecting surface 41 of the first connecting flange 15 of the first housing 8 and the second connecting flange 16 of the second housing 9. Each of the recesses 51 is a recess groove having a predetermined shape recessed (offset) relative to the second connecting surface 42 in an inner direction of the second housing 9 away from the first connecting surface 41 along a rotational axis of the valve shaft 5. Also, at least one of the multiple recesses 51 has a bottom surface that has a circular recess 52 (recess groove). More specifically, the circular recess 52 is further offset relative to the bottom surface of the recess 51 in the inner direction along the rotational axis of the valve shaft 5. In other words, there is provided a step 53 having a circular ring shape formed between the bottom surface of the recess 51 and the bottom surface of the recess 52.

Also, the second connecting flange 16 has an opposing part that opposed to the first connecting surface 41 of the first connecting flange 15. Multiple reinforcement ribs 54 and annular reinforcement rib 55 (outer edge rib) are formed at the opposing part of the second connecting flange 16. The multiple reinforcement ribs 54 defines the adjacent two recesses 51 among the multiple recesses 51. The annular reinforcement rib 55 is formed to surround an outer peripheral end part of the second connecting flange 16. The multiple reinforcement ribs 54, 55 are projection portions that project from the bottom surfaces of the multiple recesses 51 toward the first connecting surface of the first connecting flange 15, and the crest surface (projection end surface) of the projection portion has an opposing surface (the second connecting surface 42) that is opposed to the first connecting surface 41 of the first connecting flange 15 with the clearance 13 formed therebetween.

The second housing 9 has a motor case 56 and a reduction gear case 57. The motor case 56 defines therein the motor receiving space 17, and the reduction gear case 57 defines therein the gear receiving space 25. It should be noted that the motor receiving space 17 is communicated with the gear receiving space 25. Also, the gear receiving space 25 is communicated with an internal space of the first housing 8.

The reduction gear case 57 has an outer peripheral wall that projects from an intermediate wall part, which is located at a position radially inward of the bolt holder 44 of the second connecting flange 16, toward the motor along the rotational axis of the valve shaft 5. Also, the reduction gear case 57 has an opening at a right side of the reduction gear case 57. The reduction gear case 57 is fitted with the cap 10 such that the cap 10 air-tightly closes the opening of the reduction gear case 57.

It should be noted that the inner peripheral part of the second connecting flange 16 opens such that the internal space of the first housing 8 is communicated with the gear receiving space 25 of the second housing 9.

Also, a cylindrical portion 58 (inner peripheral wall) is formed at an inner peripheral part of the second connecting flange 16, and the cylindrical portion 58 is fitted with an inner periphery of the third cylindrical portion 48 of the first housing 8. A ring groove having a circular ring shape is formed at the inner peripheral part of the second connecting flange 16 near the cylindrical portion 58. A seal member 59 having a circular ring shape is mounted to the ring groove such that the seal member 59 seals the clearance 13 formed between the first connecting surface 41 of the first connecting flange 15 and the second connecting surface 42 of the second connecting flange 16. Thus, water that has entered into the clearance 13 is limited from entering inside of the second housing 9 of the actuator main body or entering into the gear receiving space 25.

The ventilation hole 11 is a circular ventilating hole (through hole) that provides communication between (a) the inside and (b) the outside of the second housing 9 of the actuator main body. For example, the inside of the second housing 9 is the gear receiving space 25 or the inner space of the second housing 9. The outside of the second housing 9 includes the space (dead volume) formed within the recess 51, the space (dead volume) formed within the recess 52, and the clearance 13. The ventilation hole 11 extends through the second connecting flange 16 in a direction of wall thickness or in the axial direction. The ventilation hole 11 extends in a direction perpendicular to the first connecting surface 41 of the first connecting flange 15. In other words, the ventilation hole 11 extends straightly along the rotational axis of the valve shaft 5.

Also, the ventilation hole 11 has an outside opening 61 and an inside opening 62.

The outside opening 61 of the ventilation hole 11 opens at an external wall surface of the second connecting flange 16 of the second housing 9, which surface is opposed to the first connecting surface 41. In other words, the outside opening 61 opens at the bottom surface of recess 52.

Also, the inside opening 62 of the ventilation hole 11 opens at an internal wall surface of the second connecting flange 16, which wall surface is on a side of the second connecting flange 16 opposite from the external wall surface or from the second connecting surface 42. In other words, the internal wall surface of the second connecting flange 16 faces the gear receiving space 25.

It should be noted that the ventilation hole 11 is formed at a position radially center of the circular recess 52, and has a diameter smaller than a diameter of the recess 52.

The waterproof ventilation filter 12 allows gas, such as air, to pass therethrough, and prohibits water from passing therethrough. In other words, the waterproof ventilation filter 12 has gas permeability and also has sufficient waterproofness. Typically, the waterproof ventilation filter 12 is a circular waterproof sheet that collects foreign objects in air, such as dusts. The waterproof ventilation filter 12 may be, for example, a sheet filter made of a Gore-Tex (registered trademark). The waterproof ventilation filter 12 is heat-fused (heat welded) to the external wall surface of the second connecting flange 16 of the second housing 9 at a position corresponding to the ventilation hole 11 such that the waterproof ventilation filter 12 covers the outside opening 61 of the ventilation hole 11. Typically, the external wall surface of the second connecting flange 16 is opposed to or faces the first connecting surface 41 of the first housing 8 and includes the bottom surface of recess 52 and an opening peripheral portion 63 of the ventilation hole 11. When the waterproof ventilation filter 12 is heated while the waterproof ventilation filter 12 is pressed against the opening peripheral portion 63 of the ventilation hole 11, the synthetic resin, which forms the opening peripheral portion 63, starts to melt, and the melted synthetic resin entangles or attaches to fibers of the waterproof ventilation filter 12. As a result, the waterproof ventilation filter 12 is fused to the opening peripheral portion 63 of the ventilation hole 11 through heat fusion.

It should be noted that the opening peripheral portion 63 of the ventilation hole 11 has a filter attachment surface having a circular ring shape, which surface is formed at the periphery of the outside opening 61 of the ventilation hole 11. The filter attachment surface serves as a mount for the waterproof ventilation filter 12, and is provided at a position that is recessed in the inner direction of the second housing 9 relative to the second connecting surface 42 of the second connecting flange 16 and relative to the bottom surface of the recess 51.

The clearance 13 is formed between the first connecting surface 41 of the first connecting flange 15 and the second connecting surface 42 of the second connecting flange 16. The clearance 13 extends downwardly in a vertical direction from at least an upper end of the first and second connecting flanges 15, 16. Also, the clearance 13 radially outwardly extends around a rotation center of the valve shaft 5, and the clearance 13 radially opens at an entire perimeter in the circumferential direction of the first and second connecting flanges 15, 16. In other words, the clearance 13 opens through 360°.

As a result, water that has entered into the clearance 13 flows from the upper side of the clearance 13 of the first and second connecting flanges 15, 16 downwardly in the vertical direction (vehicle up-down direction) toward the lower side of the clearance 13. Then, the water flows through the clearance 13 at the vertically lower-end side of the first and second connecting flanges 15, 16 to the lower side (outside) that is lower than the actuator in the vertical direction. In other words, the clearance 13 functions as a drain channel. For example, the clearance 13 is configured to allow water in the actuator to be drained out of the actuator through the clearance 13.

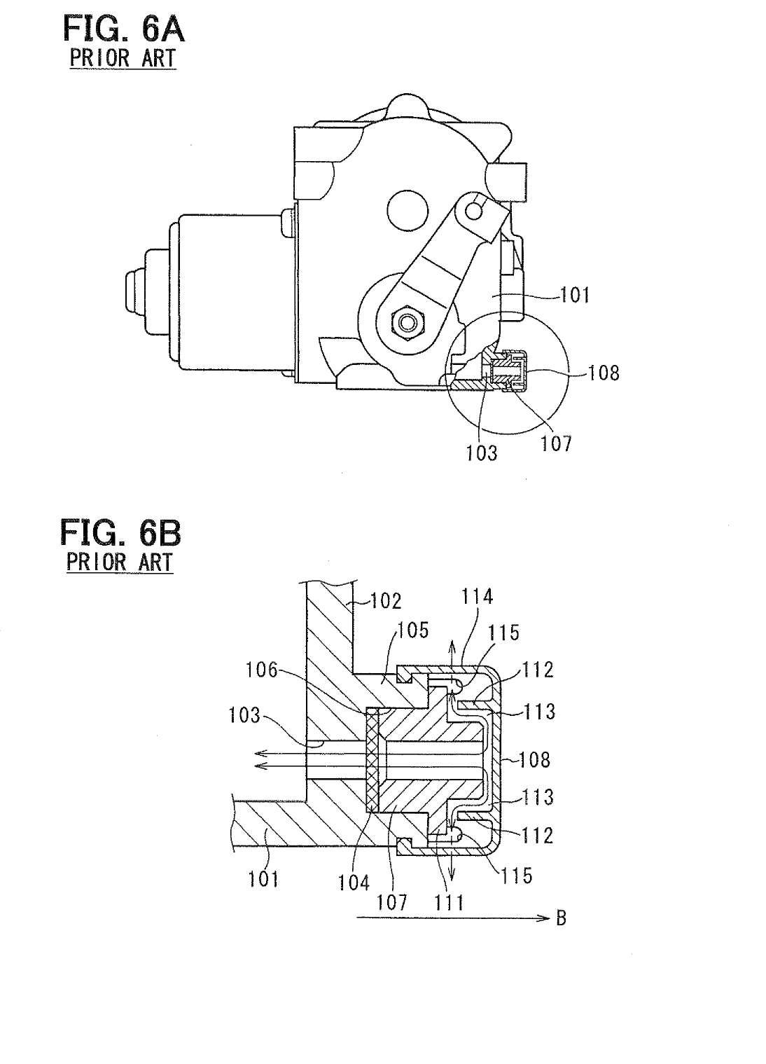

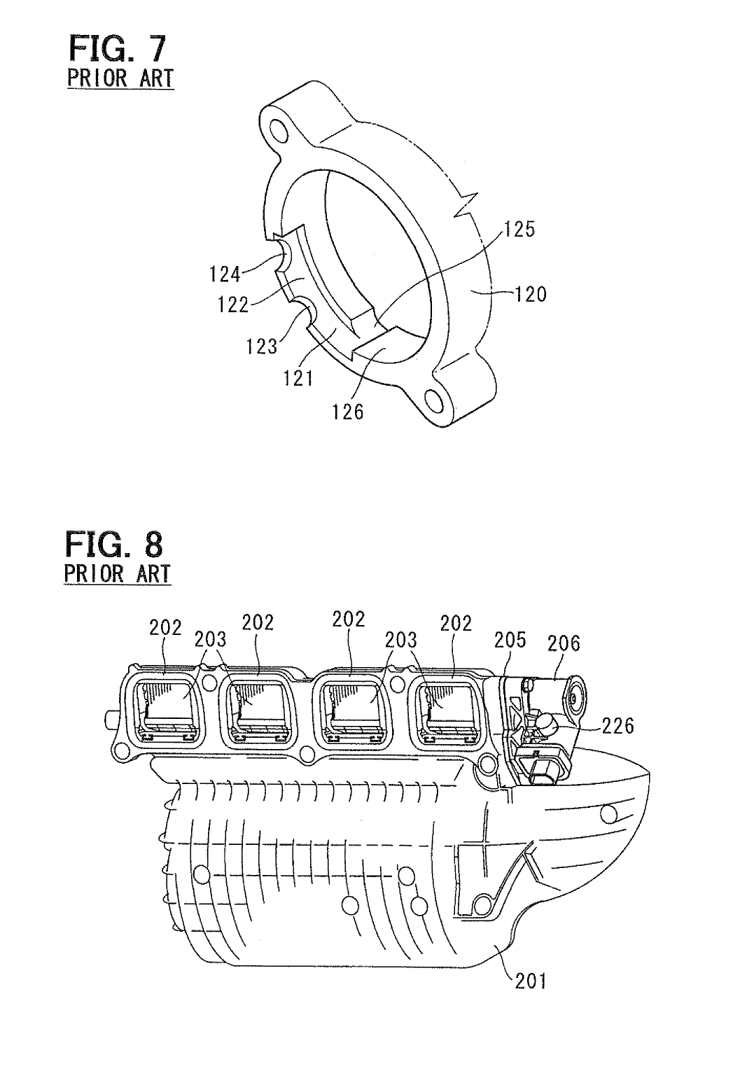

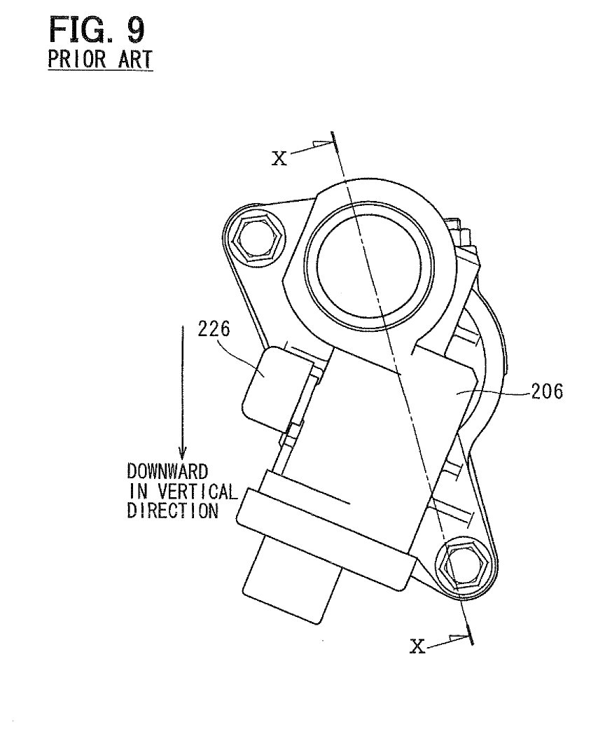

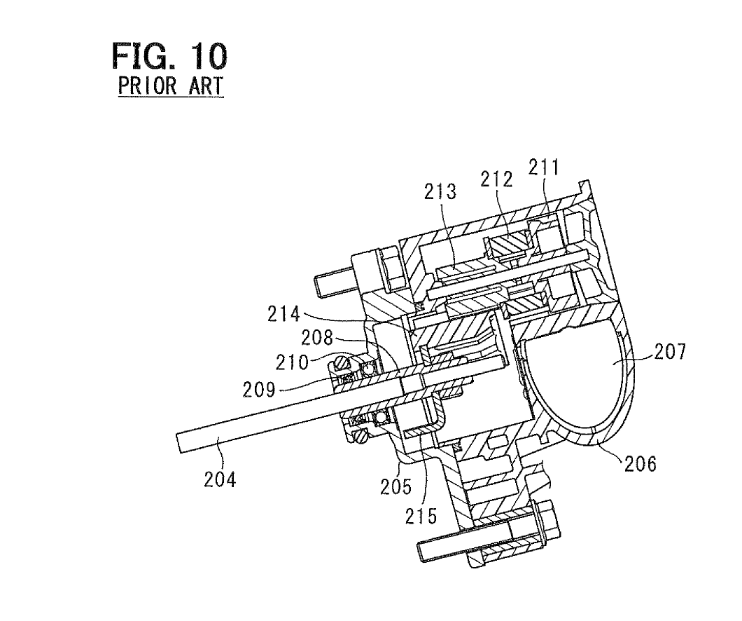

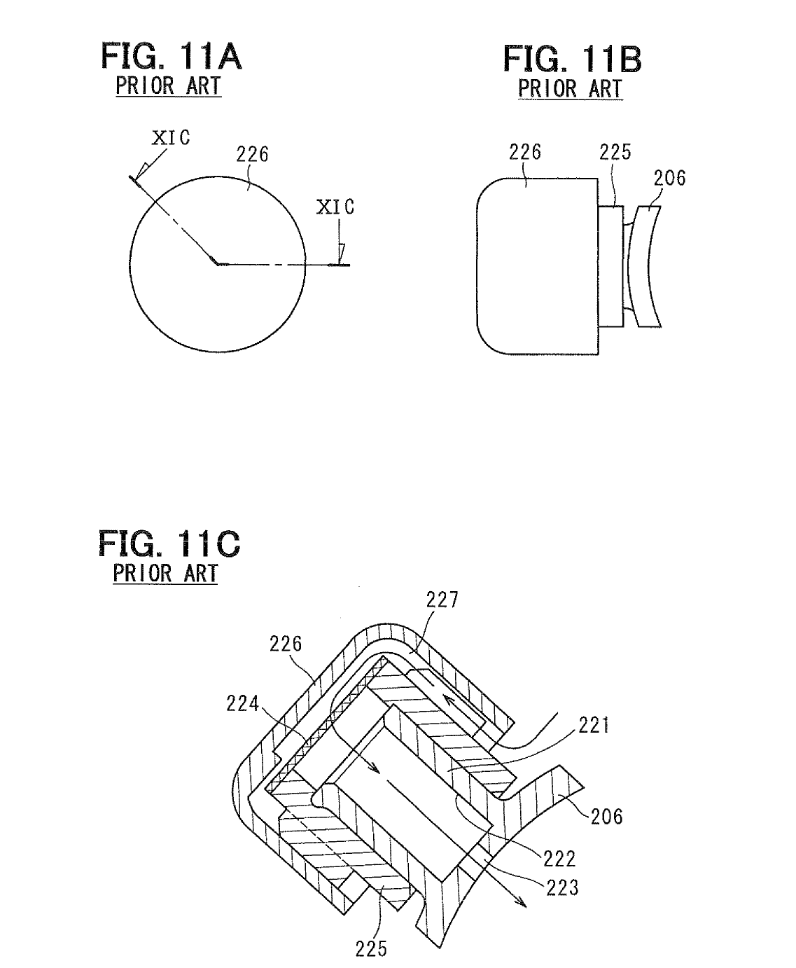

Next, operation of the air intake apparatus for the internal combustion engine of the present embodiment, or specifically, the intake vortex flow generator, will be described with reference to FIGS. 1A through 50.

When the engine is sufficiently warmed up, and also a large amount of intake air is required, the ECU controls power supply to the motor 7 that actuates the multiple valves 3. In other words, when the engine is operated under a meddle/high speed range or under a middle/high load range, the ECU controls the energization of the motor 7, for example.

Then, driving force of the motor 7 is transmitted to the worm 21, the helical gear 22, the impact force absorbing member (the first and second plates 27, 28 and the rubber elastic body 29), the spur gear 23, and the output gear 24 of the gear reduction mechanism. Subsequently, driving force of the motor 7 is transmitted to the valve shaft 5 from the stopper lever 31, which is insert-molded within the inner peripheral part of the output gear 24, through the joint shaft 6.

Thus, the connected multiple valves 3, through which the valve shaft 5 extends, are actuated in the valve opening direction by the driving force of the motor 7, and thereby the connected multiple valves 3 are opened.

In the present embodiment, the fully-opening position stopper contact is provided on one side of the bending portion 32 of the stopper lever 31 in the rotational direction. Due to the above, when the output gear 24 is rotated in the valve opening direction by the driving force of the motor 7, the stopper lever 31 is also rotated in the valve opening direction. Then, when the fully-opening position stopper contact of the stopper lever 31 collides with or contacts the fully-opening position stopper, the valve opening degree of the valve unit is regulated to be the full opening degree at the full open position.

In the above case, intake air flows into the separate intake passage formed at each cartridge 2 through the inlet portion of each cartridge 2 of the valve units from the multiple separate intake passages of the intake manifold 1 of the engine. Then, intake air flows straightly through each separate intake passage, and is introduced into the intake port provided at the cylinder head of the engine through the outlet portion of the multiple cartridges 2. Then, intake air that has passed through the intake port is supplied to the combustion chamber through an intake valve port of the intake port. In the above case, intake vortex flow (tumble flow) in the longitudinal direction is not generated in the combustion chamber of each cylinder of the engine.

In contrast, when the engine is cold, and only a small amount of intake air is required, the ECU controls power supply to the motor 7 that actuates the multiple valves 3. In other words, at the timing of starting the engine or when the engine is controlled under the stand-by operation, the ECU control the energization of the motor 7, for example.

As a result, the valve 3 is actuated in the valve closing direction by the driving force of the motor 7, and thereby the valve 3 is closed.

In the present embodiment, the fully-closed position stopper contact is provided on the other side of the bending portion 32 of the stopper lever 31 in the other rotational direction. Due to the above, when the output gear 24 is rotated in the valve closing direction by the driving force of the motor 7, the stopper lever 31 is also rotated in the valve closing direction. When the fully-closed position stopper contact of the stopper lever 31 collides with or contacts the fully-closed position stopper, the valve opening degree of the valve unit is regulated to be the full closed degree or at the full closed position.

In the above, intake air flows from the multiple separate intake passages of the intake manifold 1 of the engine to each separate intake passage through each of the inlet portions of the multiple cartridges 2. Most of the intake air passes through the clearance formed between (a) a passage wall surface of a housing upper wall part of each cartridge 2 and (b) a valve top end surface of valve 3 to be introduced to an upper layer portion of the intake port through the outlet portions of the multiple cartridges 2. Then, intake air flows along a ceiling wall surface of the upper layer portion of the intake port. Then, intake air, which flows along the ceiling wall surface of the upper layer portion of the intake port, is supplied into the combustion chamber through the intake valve port of the intake port. In the above, because tumble flow is generated in the combustion chamber of each cylinder of the engine, efficiency of combustion in the combustion chamber at the timing of starting the engine, or when the engine is operated under the stand-by operation, is effectively improved, and thereby it is possible to improve the fuel efficiency and the emission quality (for example, reduction of HC).

Advantages of the present embodiment will be described. As above, the actuator that serves as the valve drive device of the present embodiment includes the actuator main body, which contains therein the motor 7 and the drive force transmission mechanism (the gear reduction mechanism), and the first housing 8, which has the first connecting flange 15 that is connected with the actuator main body, and which is fixed to a body component (the intake manifold 1) of the vehicle, such as the automobile.

The actuator main body includes the second housing 9, which defines the inside (the gear receiving space 25) and the outside of the main body. Also, the actuator main body includes the ventilation hole 11, which extends through the second connecting flange 16 of the second housing 9 in the thickness direction such that the ventilation hole 11 connects the inside (the gear receiving space 25) with the outside. The ventilation hole 11 has the outside opening 61 that opens at the external wall surface of the second connecting flange 16, which wall surface faces the first connecting surface 41. Also, the ventilation hole 11 has the inside opening 62 that opens at the internal wall surface of the second connecting flange 16, which wall surface is positioned on the side of the second connecting flange 16 opposite from the external wall surface and away from the first connecting surface 41.

The outside opening 61 of the ventilation hole 11 is closed by the waterproof ventilation filter 12 (waterproof sheet), which has gas permeability and sufficient waterproofness.

Also, the clearance 13 is formed between (a) the first connecting surface 41 of the first connecting flange 15 of the first housing 8 and (b) the second connecting surface 42 of the second connecting flange 16 of the second housing 9. Typically, the clearance 13 radially opens at the entire perimeter or open through 360° in the circumferential direction of the actuator (or of the first and second connecting flanges 15, 16). The clearance 13 extends downwardly in the vertical direction from at least the upper end of the first and second connecting flanges 15, 16.

Because of the above ventilation hole waterproof structure of the actuator, it is possible to ventilate the actuator (or the first and second housings 8 and 9) through the ventilation hole 11 and the clearance 13 in any direction by 360 degrees, and thereby it is possible to drain water in any direction. As a result, water that has entered into the clearance 13 is easily drained to the outside of the actuator (the first and second housings 8 and 9). While the water in the clearance 13 is drained out of the actuator, water is capable of effectively washing out the foreign objects attached in the clearance 13, such as sludge or dusts. As a result, the ventilation hole 11 or the clearance 13 are effectively limited from being clogged by the foreign objects.

Also, even in a case, where a part of the clearance 13 is clogged by foreign objects, it is possible to ventilate through the ventilation hole 11 and the other part of the clearance 13. Thus, it is possible to achieve high reliability against the clogging of the ventilation hole 11 caused by the foreign objects, such as sludge or dusts.

Also, the clearance 13 formed between (a) the first connecting surface 41 of the first connecting flange 15 and (b) the second connecting surface 42 of the second connecting flange 16 does not have a maze-like structure of the conventional art. Thus, it is possible to reduce cost without increasing the size of the actuator or without making the ventilation hole structure complicated.

Also, the present embodiment does not require a filter attachment structure of the conventional art, in which the filter 104 is interposed between the bush 107 and the cap 108, nor another filter attachment structure of another conventional art, in which the filter 224 is interposed between the bush 225 and the cap 226. Specifically, in the present embodiment, the waterproof ventilation filter 12 is fixed, through heat fuse, to the external wall surface of the second connecting flange 16, which wall surface is opposed to the first connecting surface 41. Thus, as above, the bushes 107, 225 and the caps 108, 226 of the conventional art are both eliminated in the present embodiment. As a result, compared with the conventional art, the number of components and assembly manpower are effectively reduced, and thereby it is possible to effectively reduce cost.

Also, the present embodiment does not employ the conventional ventilation hole waterproof structure, in which the projection cylindrical portion 221 outwardly projects from the external wall surface of the housing 206, and the bottom surface of recess 222 of the projection cylindrical portion 221 is provided with the ventilation hole 223. In the conventional art, the filter 224 covers the ventilation hole 223. Specifically, the present embodiment employs the ventilation hole 11, which has the outside opening 61 opening at the external wall surface of the second connecting flange 16 of the second housing 9. As a result, the size of the actuator is effectively reduced. Due to the above, it is possible to obtain the mount space in the engine room of the vehicle, in which space the component is mounted, and thereby it is possible to improve the ease of mounting to the vehicle.

Also, because the outside opening 61 of the ventilation hole 11 is closed by the waterproof ventilation filter 12, it is possible to prevent the entry of the water into the second housing 9 (or to the gear receiving space 25) during the ventilation. As a result, it is possible to prevent the water from entering into the gear receiving space 25 of the actuator main body with low cost. Thus, because the outside opening 61 of the ventilation hole 11 is closed by the waterproof ventilation filter 12, it is possible to achieve high reliability in the prevention of the water entry caused during the ventilation.

Also, the dead space formed within the recesses 51, 52 is used for fixation of the waterproof ventilation filter 12 to the external wall surface of the second connecting flange 16 of the second housing 9, which wall surface is opposed to the first connecting surface 41. For example, the dead space corresponds to a recess part formed on the external wall surface of the second connecting flange 16 of the second housing 9. As a result, the mount space for the waterproof ventilation filter 12 is not required, and thereby it is possible to reduce the size of the actuator. Accordingly, it is possible to easily obtain the mount space in the engine room of the vehicle, and thereby it is possible to improve ease of mounting to the vehicle.

Also, as above, it is possible to ventilate the actuator by the entire perimeter of 360° through the ventilation hole 11 and the clearance 13 of the actuator. Thus, regardless of the mount direction of the component of the actuator main body relative to the first connecting surface 41 of the first connecting flange 15, it is possible to drain water, which has entered into the clearance 13, to the lower side in the vertical direction. As a result, it is possible to drain water out of the actuator through the vertical lower end portion of the first and second connecting flanges 15, 16 to the vertically lower part that is lower than the vertical lower end portion of the flanges 15, 16 in the vertical direction. In the above, the component of the actuator main body is the element of the actuator main body, such as the second housing 9, for example.

As above, because the structure does not require a specific mount direction of the component, it is possible to easily standardize the component, and thereby it is possible to reduce cost by sharing the common assembly facility advantageously.

As a result, because it is possible to remove the limitation of the mount direction of the component in the engine room of the vehicle, it is possible to share and standardize the actuator or the engine room on-board component. As a result, it is possible to effectively reduce cost.

Also, the clearance 13 formed between the first connecting surface 41 of the first connecting flange 15 and the second connecting surface 42 of the second connecting flange 16 functions as the drain channel that drains water in the clearance 13 directly to the vertical lower side of the second housing 9. Also, because the clearance 13 opens at the entire perimeter in the circumferential direction of the first and second connecting flanges 15, 16 in 360°, water in the clearance 13 is effectively drained to the vertical lower side. Accordingly, it is possible to drain water out of the actuator through the vertical lower end portion of the first and second connecting flanges 15, 16 to the vertical lower side that is vertically lower than the actuator. Thus, it is not required to change the position of the drain structure (drain hole) in accordance with the mount direction of the component (the second housing 9) of the actuator main body relative to the first connecting surface 41 of the first connecting flange 15. Thus, it is possible to easily to standardize the component (the second housing 9) of the actuator main body. Thereby, it is possible to reduce cost by sharing the assembly facility.

As a result, it is possible to remove the limitation in the mount direction of the component in the engine room of the vehicle, and thereby it is possible to share and standardize the actuator or the engine room on-board component. Thereby, it is possible to effectively reduce cost.

### (Modification)

In the above embodiment, the intake vortex flow generator is designed to generate intake vortex flow (tumble flow) in the longitudinal direction in order to enhance the combustion of air-fuel mixture in the combustion chamber of each cylinder of the engine. However, the intake vortex flow generator may be alternatively designed to generate intake vortex flow (swirl flow) in the lateral direction in order to enhance the combustion of air-fuel mixture in the combustion chamber of each cylinder of the engine. Alternatively, the intake vortex flow generator may be designed to generate squish flow in order to enhance the combustion of the engine.

In the above embodiment, the present invention is applied to the intake vortex flow generator of the internal combustion engine. However, the present invention may be applicable to the electronic throttle apparatus (throttle apparatus for the internal combustion engine) and to a variable intake system for the internal combustion engine, in which system the length of the intake passage and the cross-sectional area of the intake passage are changeable.

In the above embodiment, the actuator main body includes the motor 7, the drive force transmission mechanism (for example, the gear reduction mechanism), and the second housing 9 (the motor case 56, the reduction gear case 57). However, the actuator main body, which actuates the mobile object (rotor), such as a valve, may include only a motor and a housing (motor case). Also, a valve biasing device (spring) for biasing the valve in the valve opening direction or in the valve closing direction may not be alternatively provided.

Also, in the above embodiment, the valve unit (tumble flow control valve) serves as an intake control valve that has a valve provided in an intake passage formed in the casing, such as an intake duct or the intake manifold 1. The intake control valve controls intake air that is suctioned to the combustion chamber of the internal combustion engine. Alternatively, an intake flow amount control valve may be provided instead of the above intake control valve. The intake flow amount control valve has a throttle valve that is provided in an intake passage formed in a throttle body so that the intake flow amount control valve controls a flow amount of intake air that is suctioned into the combustion chamber of the internal combustion engine. Also, further alternatively, another intake flow amount control valve may be employed. The alternative intake flow amount control valve has an idle rotation speed control valve that is provided in an intake passage formed in the housing such that the intake flow amount control valve controls a flow amount of intake air bypassing the throttle valve.

Also, instead of the above intake flow control valve or the above intake flow amount control valve, the intake control valve having the casing and the valve may alternatively an intake passage opening/closing valve, an intake passage switching valve, or an intake pressure control valve. Also, the intake control valve may be applicable to an intake flow control valve, such as a tumble flow control valve (one embodiment) or a swirl flow control valve. Further, the intake control valve may be applicable to a variable intake control valve that changes the length or the cross-sectional area of the intake passage of the internal combustion engine. Also, a diesel engine may be employed as an internal combustion engine. Also, a single cylinder engine may be employed as an internal combustion engine instead of the multiple cylinder engine.

Also, the mobile object (valve, such as a rotor) of the present embodiment may be applicable to an intake control valve, an exhaust gas control valve, an idle rotation speed control valve, and an exhaust gas recirculation control valve (EGR control valve). The intake control valve controls an amount of intake air delivered into the combustion chamber of the engine. The exhaust gas control valve controls an amount of exhaust gas that is discharged from the combustion chamber of the engine. The idle rotation speed control valve controls an amount of intake air that bypasses the throttle valve. The EGR control valve controls recirculation amount of exhaust gas, which is a part of exhaust gas discharged from the combustion chamber of the engine, and which recirculates from the exhaust passage to the intake passage.

In the present embodiment, the ventilation hole 11 is provided at the bottom surface of the dead space (recess part) formed between (a) the bottom surface of the recesses 51, 52 of the second connecting flange 16 of the second housing 9 and (b) the first connecting surface 41 of the first connecting flange 15 of the first housing 8. For example, the bottom surface of the recesses 51, 52 of the second connecting flange 16 faces the first connecting surface 41 of the first connecting flange 15. Alternatively, there may be provided a ventilation hole that has an outside opening at the second connecting surface 42 of the second connecting flange 16 of the second housing 9 of the actuator main body.

In the present embodiment, the on-board component (engine room on-board component) employs the actuator (electric actuator) that has the motor 7, the drive force transmission mechanism (the gear reduction mechanism), and the ventilation hole waterproof structure. Alternatively, the on-board component (engine room on-board component) may employ an electromagnetic actuator or a vacuum operated actuator. Typically, the electromagnetic actuator has a solenoid coil and the ventilation hole waterproof structure, and the vacuum operated actuator has a diaphragm and the ventilation hole waterproof structure.

Also, the on-board component (engine room on-board component) may employ an electronic control device that has an electronic component and the ventilation hole waterproof structure.

Also, the attachment member fixed to the body of the vehicle may include a bracket, an intake manifold, an engine main body, and a fuel tank. The on-board component main body is mounted to the bracket to be fixed to the vehicle body, for example.

In the present embodiment, the clearance 13 is formed between (a) the first connecting surface 41 of the first connecting flange 15 and (b) the second connecting surface 42 of the second connecting flange 16. Specifically, the clearance 13 formed at the inner peripheral part of the first and second connecting flanges 15, 16 is air-tightly sealed by the seal member 59. Alternatively, a clearance formed between (a) the inner peripheral surface of the third cylindrical portion 48 of the first housing 8 and (b) the outer peripheral surface of the cylindrical portion 58 of the second connecting flange 16 may be fluid-tightly or air-tightly sealed by a seal member.

Also, an opposing surface of the bolt holder 44 of the second connecting flange 16 may be offset or displaced further toward the first connecting surface 41 relative to an opposing surface (crest surface, the second connecting surface 42) of each reinforcement rib 54, 55 of the second connecting flange 16. For example, the opposing surface of the bolt holder 44 and the opposing surface of each reinforcement rib 54, 55 face toward the first connecting surface 41. As a result of the above offset arrangement, the clearance 13 is effectively formed between the first connecting surface 41 of the first connecting flange 15 and the second connecting surface 42 of the second connecting flange 16 by making

Also, an axial dimension of the metal collar 49 fitted within the second through hole 45 of the second connecting flange 16 may be set greater than a thickness of the bolt holder 44 of the second connecting flange 16 (or than an axial dimension of the second through bore 45). In the above case, the second housing 9 is fastened to the housing fitting part 46 of the intake manifold 1 through the first housing 8 by using the fastening bolt 14. Thus, the opposing surface of the metal collar 49 is displaced toward the first connecting surface relative to the opposing surface of each reinforcement rib 54, 55 of the second connecting flange 16. In the above, the opposing surface of the metal collar 49 faces toward the first connecting surface 41. As a result, the clearance 13 is formed between the first connecting surface 41 of the first connecting flange 15 and the second connecting surface 42 of the second connecting flange 16.

Also, in the above embodiment, the filter attachment surface is formed at a position that is recessed at the second connecting flange 16 of the second housing 9 in the inner direction of the second housing 9 relative to the second connecting surface 42 of the second connecting flange 16 and the bottom surface of the recess 51. Alternatively, the recess 52 may be eliminated, and the filter attachment surface may be provided at a position that is recessed in the inner direction of the second housing 9 relative to the second connecting surface 42 of the second connecting flange 16. In other words, the filter attachment surface may be provided at a position that is recessed by two or more levels (steps) at the second connecting flange 16 relative to the second connecting surface 42 of the second connecting flange 16. Also, the filter attachment surface may be provided at a position that is recessed by a single lever (step) at the second connecting flange 16 relative to the second connecting surface 42 of the second connecting flange 16.

In the present embodiment, the ventilation hole 11 (straight line passage) having a linear shape straightly extends in a direction perpendicular to the first connecting surface 41 (attachment surface of attachment member) of the first connecting flange 15 of the first housing 8. Alternatively, a ventilation hole (inclined passage) having a linear shape may be provided, which ventilation hole straightly extends in a direction that is angled relatively to the first connecting surface 41 (attachment surface of attachment member) of the first connecting flange 15 of the first housing 8 by a predetermined inclination angle. Also, the ventilation hole may have a bent shape.

In the present embodiment, the multiple reinforcement ribs 54, 55 are provided to the second connecting flange 16 of the second housing 9. The crest surface of each of the reinforcement ribs 54, 55 serves as the opposing surface (the second connecting surface 42) that is provided to be opposed to the first connecting surface 41 of the first connecting flange 15 with the clearance 13 formed between the crest surface and the first connecting surface 41. The reinforcement rib may not be formed at the opposing part of the second connecting flange 16 of the second housing 9, which opposing part is opposed to the first connecting surface 41 of the first connecting flange 15 with the clearance 13 formed therebetween.

Additional advantages and modifications will readily occur to those skilled in the art. The invention in its broader terms is therefore not limited to the specific details, representative apparatus, and illustrative examples shown and described.

What is claimed is:

1. A ventilation hole waterproof structure of an on-board component mounted on a vehicle, comprising:
an on-board component main body that includes:
a housing defining an inside and an outside of the housing;
a ventilation hole provided to the housing to extend through the housing such that the ventilation hole provides communication between the inside and the outside of the housing; and
a waterproof filter provided at a position that corresponds to the ventilation hole; and
an attachment member that has a connecting part connected to the on-board component main body, the attachment member being fixed to a body of the vehicle, wherein:
the attachment member has an attachment surface that extends from at least an upper end of the connecting part downwardly in a vertical direction;
the housing has a connecting surface, which is connected to the connecting part of the attachment member, and which is opposed to the attachment surface of the attachment member with a clearance formed between the connecting surface and the attachment surface;
the ventilation hole has an outside opening that opens at an external wall surface of the housing, which wall surface is opposed to the attachment surface; and
the waterproof filter is fixed to the external wall surface of the housing by heat fusion such that the waterproof filter covers the outside opening of the ventilation hole.

2. The ventilation hole waterproof structure according to claim 1, wherein:
the clearance serves as a drain channel.

3. The ventilation hole waterproof structure according to claim 1, wherein:
the clearance opens at an entire perimeter in a circumferential direction of the connecting part of the attachment member and the housing.

4. The ventilation hole waterproof structure according to claim 1, wherein:
the ventilation hole is a through hole that extends from the outside opening of the housing in a direction away from the attachment member.

5. The ventilation hole waterproof structure according to claim 1, wherein:
the external wall surface of the housing includes an annular filter attachment surface around the outside opening of the ventilation hole;
the filter attachment surface is attached with the waterproof filter; and
the filter attachment surface is provided at a position that is displaced from the connecting surface of the housing in a direction away from the attachment member.

6. The ventilation hole waterproof structure according to claim 1, wherein:
the housing has a flange that is opposed to the connecting part of the attachment member; and
the flange has a reinforcement rib having an opposing surface that is opposed to the attachment surface of the attachment member with a clearance formed between the opposing surface and the attachment surface.

7. The ventilation hole waterproof structure according to claim 1, wherein:
the on-board component main body is an actuator main body valve mounted in an engine room of the vehicle for actuating a valve.

8. The ventilation hole waterproof structure according to claim 1, wherein:
the clearance is configured to allow water in the on-board component to be drained out of the on-board component therethrough.
